(19) United States
(12) Patent Application Publication
(10) Pub. No.: US 2008/0320240 A1
(43) Pub. Date: Dec. 25, 2008

(54) Method and arrangements for memory access

(75) Inventor: Andjelija Savic, Beograd (YU)

Correspondence Address: Alan Carlson, 6202 Lynn Lane, Lago Vista, TX, 78645, US

(73) Assignee: On Demand Microelectronics

(21) Appl. No.: 11/821,420

(22) Filed: Jun. 22, 2007

(51) Int. Cl. G06F 12/00

(52) U.S. Cl. 711/151; 711/E12.001

(57) ABSTRACT

In one embodiment a multi-input, multi output memory system is disclosed. The system can include a plurality of single ported memory modules, an identifier module to provide an identify to each memory access requests of a plurality of memory access requests. The identity can include a port that receives the memory access request. The system can include a memory access controller coupled to the plurality of single ported memory modules that can control movement of the requests.

### FIELD OF THE INVENTION

This disclosure relates to a multiple input multiple output memory system and to methods and arrangements for operating a multiple input multiple output memory system.

### BACKGROUND OF THE INVENTION

Computing platforms that have multiple processing cores are becoming more and more popular due to their relatively low cost and the speed at which they can process a task. These multi-core platforms can process data much faster than traditional single core platforms. It can be appreciated that each core can try to access the system memory at the same time and thus, a single input single output memory system can get overloaded by a multi-core processor and the memory system can create a significant bottleneck to system performance. Thus, in order for a multi-core system to operate most efficiently a multiple input multiple output memory system is needed to compliment a multi-core processor system.

Accordingly, multiple input, multiple output memory systems are very useful because they can handle multiple memory access requests simultaneously. Such concurrent memory retrieval efforts can make a computing system very fast and efficient. However, such memory systems are relatively expensive when compared to traditional single input, single output systems. What would be desirable is a simplified low cost multiple input multiple output memory system.

### SUMMARY OF THE INVENTION

In one embodiment a multi-input, multi output memory system is disclosed. The system can include a plurality of single ported memory modules, an identifier module to provide an identify to each memory access requests of a plurality of memory access requests. The identity can include a port that receives the memory access request. The system can include a memory access controller coupled to the plurality of single ported memory modules that can control movement of the requests.

The memory access controller can have a plurality of inputs to accept the plurality of memory requests simultaneously of on a concurrent basis and can prioritize and queue the identified memory access request to one single ported memory module of the plurality of single ported memory modules. The system can also include a router to route results of the memory access request provided by the memory modules to an output port of a plurality of output ports based on the identity of the memory access request. The memory access controller can include a plurality of access queue modules to feed the plurality of single port memory modules with the memory requests.

The system can have an input port with multiple inputs that coupled to the single ported memory modules. The input port can have a plurality of inputs where the inputs can be correlated to the plurality of output ports and identifiers can be utilized to facilitate such coordination. This correlation allows results of the memory request that are returned from the memory modules to be sent to the output port that correlates to the input port where the request was received based on the identity of the memory access request.

The system can also have a plurality of output queue modules where an output from a memory module can be sent to the output queue module. The output que modules can store the output and then forward this output to one of the plurality of output ports. In one embodiment, data can be organized in memory such that concurrent memory access requests are more often than not routed to different single ported memory modules in the plurality of memory modules. The memory system can include a scheduler, to schedule the plurality of requests and a prioritization module to prioritize the plurality of requests. The prioritization module can prioritize a read request over a write request because the delay of a read request can have a larger impact on system performance than the delaying a write request.

In another embodiment, a method for operating a memory system is disclosed. The method can include receiving a plurality of memory access requests at a plurality of ports, tagging the memory access request with a port identifier based on a port in the plurality of ports that the memory access request is received, prioritizing the requests, detecting addresses of the requests, routing one request from the plurality of requests to a single port memory module based on the detected address of the request, and routing a result of the one request to an output port based on the tagging.

The method can also include storing data in the memory modules based on a predicted order of receiving the memory access requests. Prioritizing can include prioritizing a read memory access request with a higher priority than a write memory access request. Routing can include routing the memory access request to an access queue and a routing table could be utilized to route the request. The method can provide one request from an access queue to the single input memory module for each memory access cycle.

In another embodiment, a computer program product is disclosed that when executed on a computer allows the computer operate a multiple input multiple output memory system. The program product when executed can receive a plurality of memory access requests at a plurality of ports, assign an identity the memory access request based on a port of the plurality of ports that the memory access request is received, prioritize the requests, detect addresses of the requests, route one request from the plurality of requests to a single port memory module based on the address of the request, and route a result of the one request to an output port based on the identity.

The program product when executed can also cause the computer to store data in the memory modules based on a predicted processing order of the data. Storage of data in this order can provide that a high percentage of the time memory access requests are relatively evenly distributed over the plurality of memory modules. This distribution of activity allows the system to operate more efficiently. When executed the code can cause the computer to prioritize a read memory access request as a higher priority than a write memory access request. The program product when executed on a computer can cause the computer to route the memory access request to an access queue. The program product when executed on a computer causes the computer to bypass the access queue in response to the access queue being empty.

### BRIEF DESCRIPTION OF THE DRAWINGS

In the following the disclosure is explained in further detail with the use of preferred embodiments, which shall not limit the scope of the invention.

FIG. 1a shows in simplified form four parallel processing units which can in parallel access four memories through a multi-port access control module;

FIG. 1b shows the embodiment 100 of FIG. 1a in more detail;

FIG. 2 is a block diagram of a processor architecture having parallel processing modules;

FIG. 3 is a block diagram of a processor core having a parallel processing architecture;

FIG. 4 is an instruction processing pipeline using a data memory subsystem (DMS) control module;

FIG. 5 is a block diagram of an architecture which enables four parallel ports 501 access to four single ported memories 550;

FIG. 6 is a block diagram of a priority module consisting of an access sorter 610, an access sorter route control module 620, and a switching logic 630;

FIG. 7 is a decision table which can be used in an access sorter;

FIG. 8 is a block diagram of an access sorter route control;

FIG. 9 is a block diagram of a port router;

FIG. 10 is a block diagram of a memory access queue control module;

FIG. 11 is a block diagram of a reverse router;

FIG. 12 is a block diagram of an output router;

FIG. 13 is a block diagram of a memory output queue control module.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In one embodiment, methods, apparatus and arrangements for issuing asynchronous memory load requests in a multi-unit processor that can execute very long instruction words (VLIW)s is disclosed. The processor can have a plurality of processing units, an instruction pipeline, a register file, and access internal and external memories. In one embodiment, methods, apparatus and arrangements for asynchronously reading data of a memory and in another embodiment, methods, apparatus and arrangements for accessing data of a register for which an asynchronous memory load request has been issued is disclosed.

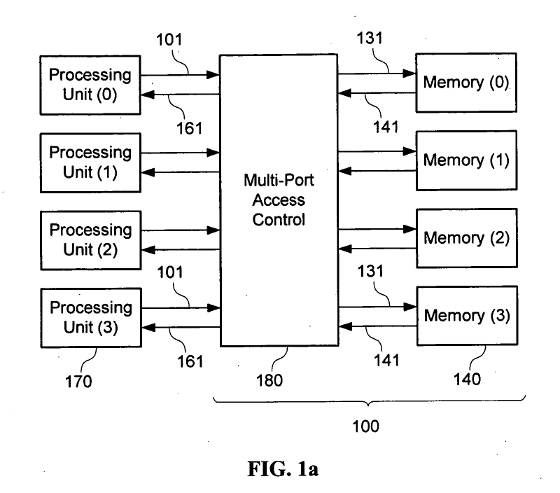

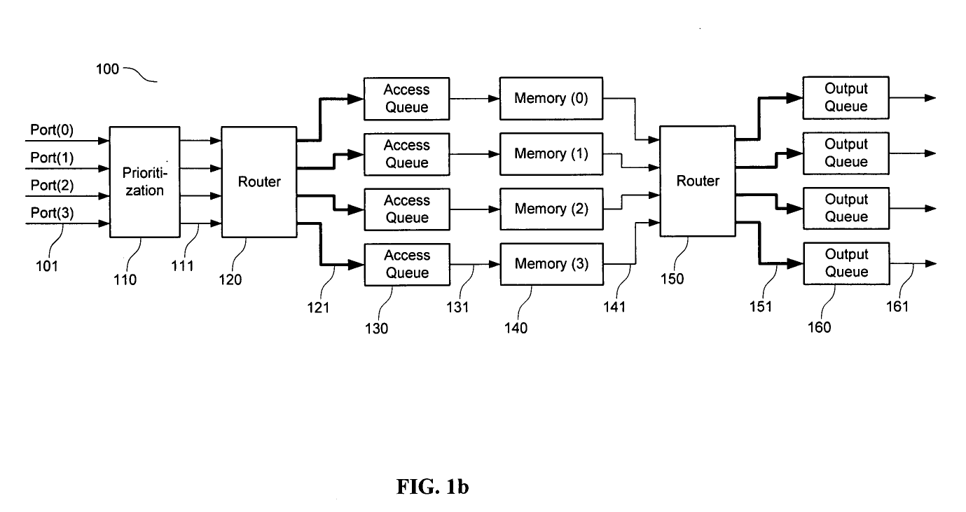

FIG. 1a and FIG. 1b show block diagrams of an embodiment of the disclosure. FIG. 1a shows in a simplified form a multitude of parallel processing units, or “K” parallel processing units 170 which can, in parallel access a multitude of memory modules illustrated as “L” memory modules 140 via a multi-port memory access control module 180. In the illustrated embodiment K=4 and L=4. However, it can be appreciated that the architecture disclosed is scalable and thus a system can include more or less modules and not pert from the scope of this disclosure. Each of the processors 170 can send a request using the connections 101 to the multi-port memory access control module 180 which can assist in executing the requests. Each connection 101 from a processing unit 170 to the control module 180 can represent a port. A request can be a read request to read data from a memory address or can be a write request to write data to a specific memory address provided by a specific memory module 140. The control module 180 can handle, prioritize, and/or queue the requests and can forward requests 131 to the memory modules 140. In case of a read request, results such as data 141 can be returned by the memory modules 140 to the control module 180. The control module 180 can queue the results of the request and can return the results to the processing units 170. The parallel processing units 170 can be processing units of a VLIW (very long instruction word). In addition the processing units 170 can be operated in a SIMD (single instruction multiple data) or a MIDM (multiple instruction multiple data) mode.

FIG. 1b shows the embodiment 100 of FIG. 1a in more detail. A prioritization module 110 can receive requests from K external ports 101. The external port can be utilized to convey signals, instructions and/or data between the module 180 and a processing unit 170. In during each clock cycle each external port 101 can issue a no data or results to a request depending on the instruction stream processed in the processors. Therefore, in each clock cycle from zero to K requests can be provided by the K ports. The prioritization module 110 can prioritize and/or sort function provided by the external ports and send the configuration of the ports (the so-called internal ports) 111 to a router module 120. The router module 120 can route the internal-ports 111 to a multitude of L access queues 130. Each of the queues 130 can be associated to a memory 140 and can act as a master to that memory 140.

Therefore, the modules 110 to 140 can enable K ports to concurrently access L memories whereas concurrently means that in one clock cycle up to K processing units 170 can issue requests to the same memory. However, simple memories 140 (single ported memories) can only handle one request at a clock cycle. Therefore, each memory can have an access queue 130 to queue the requests. Each access queue 130 can receive up to K requests in each clock cycle which is illustrated by the fat arrow 121. Each queue can store up to “N” requests and can issue at least one request at a clock cycle to the associated memory 140.

In one embodiment, a processor of the parallel processing units 170 can have a memory subsystem (not shown) that manages requests which are sent to the multi-port memory access control module 180. Accordingly, the multi-port access control module 180 can be built in a way that it never stalls when the lengths of the queues are at least as large as the sum of all requests that can be sent out by the memory subsystem for each processing unit.

In some embodiments of the disclosure, the memory subsystem can assign a unique tag to each request while other embodiments may use a counter to determine how much requests are sent by the processing units. However, if the access queues 130 can only store fewer requests, the access queues 130 can cause in some embodiments the pipeline of the processor to stall unless enough room is available in the queues to receive the next requests. However, it is to note, that the access queues 130 and the subsequent logic in the embodiment 100 may never stall and that each access queue 130 can issue at least one request to the associated memories at each clock cycle.

In case of a read request, data which is read from a memory 140 can be sent back to the requesting processing unit 170 which can be performed by a so-called reverse router as shown by the blocks 140, 150, and 160. A router 150 can receive the data which were read from the memories and can route them to output queues 160. Each output queue 160 can be assigned to a processing unit (or external port). The output queue can retrieve and store in some embodiments the data and in other embodiments the data and the tag (which was assigned to the request)—the so-called request responses. The router can send in each clock cycle up to L request responses to an output queue 160 which is illustrated by the fat arrow 151. In case the output queue can store at least the same number of requests as tags are available (or as requests can be issues by processing units to the module 180), the output queue 160 will never stall.

However, in other embodiments of the disclosure, tags may be only tied to read requests and can be irrelevant for write requests. In this case, write requests are not administered with tags and, hence, may not be assigned a tag, the access queues could run into an overflow as the number of write requests is not controlled. Therefore, logic to stall the pipeline to prevent an overflow of the access queues can be added and the lengths of the access queues can be chosen according to the estimations or design parameters.

Advantages of the disclosure are that a multitude of K parallel processing units 170 can access a multitude of L memory modules 140 using a multi-port access control module 180 whereas the memory can be simple single ported memories. The multi-port access control module 180 allows a simple implementation with a low number of logic elements and may never stall if the queues have an appropriate length (the lengths of the queues must be larger than tags for requests are available).

However, in some embodiments the memory access queue can cause the pipeline to stall in case of a memory access queue overflow (if no tags are available or if the queue lengths are smaller than the number of tags which are available) but the access queue itself will never stall. The multi-port access control 180 can handle L memory requests at each clock cycle and is completely scalable and can serve an arbitrary number of processing units in combination with an arbitrary number of memories. Other advantages are that the multi-port access control 180 can prioritize or sort incoming requests and can resolve concurrent memory requests.

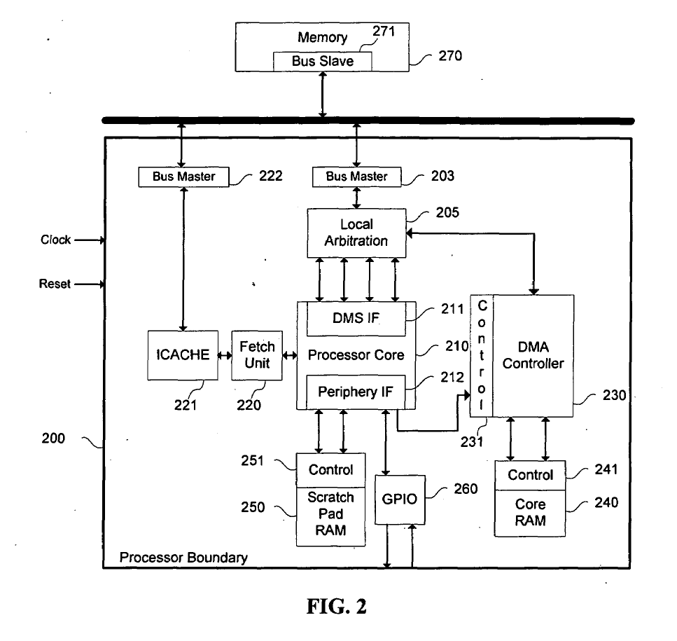

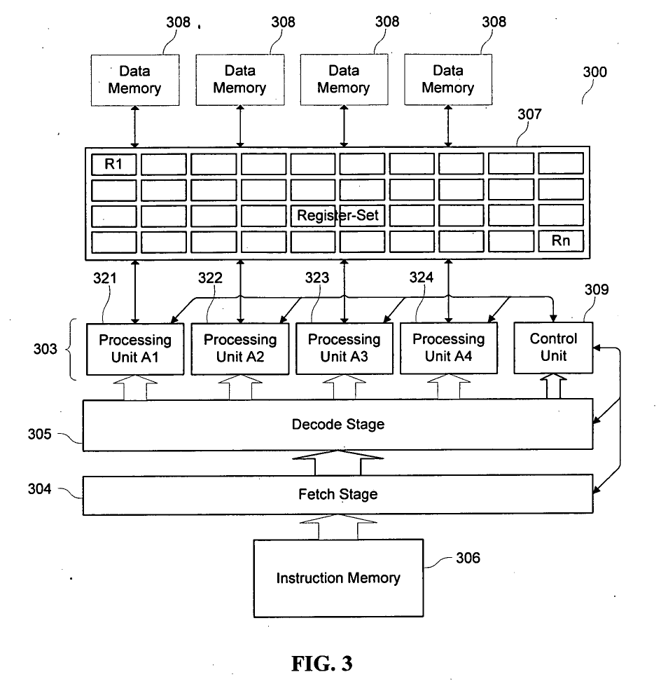

FIG. 2 shows a block diagram overview of a processor 200 which could be utilized to process image data, video data or perform signal processing, and control processing tasks. The processor 200 can include a processor core 210 which is responsible for computation and executing instructions loaded by a fetch unit 220 which performs a fetch stage. The fetch unit 220 can read instructions from a memory unit, such as an instruction cache memory 221 which can acquire and cache instructions from an external memory 270 over a bus or interconnect network.

The external memory 270 can utilize bus interface modules 222 and 271 to facilitate such an instruction fetch or instruction retrieval. In one embodiment, the processor core 210 can utilize four separate ports to read data from a local arbitration module 205 whereas the local arbitration module 205 can schedule and access the external memory 270 using bus interface modules 203 and 271. In one embodiment, instructions and data are read over a bus or interconnect network from the same memory 270 but this is not a limiting feature, instead any bus/memory configuration could be utilized such as a “Harvard” architecture for data and instruction access.

The processor core 210 could also have a periphery bus which can be used to access and control a direct memory access (DMA) controller 230 using the control interface 231, a fast scratch pad memory over a control interface 251, and to communicate with external modules, a general purpose input/output (GPIO) interface 260. The DMA controller 230 can access the local arbitration module 205 and read and write data to and from the external memory 270. Moreover, the processor core 210 can access a fast core RAM 240 to allow faster access to data. The scratch pad memory 250 can be a high speed memory that can be utilized to store intermediate results and data that is frequently utilized by the processors. The fetch and decode method and apparatus can be implemented in the processor core 210.

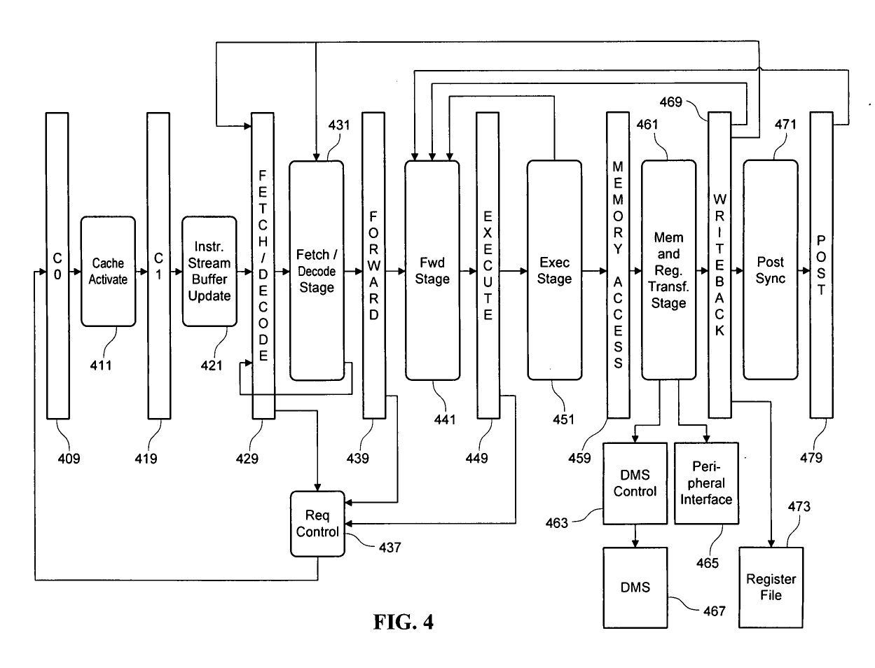

FIG. 3 shows a high-level overview of a processor core 300 which can be part of a processor having a multi-stage instruction processing pipeline. The processor 300 shown in FIG. 3 can be used as the processor core 210 shown in FIG. 2. The processing pipeline of the processor core 301 is indicated by a fetch stage 304 to retrieve data and instructions, a decode stage 305 to separate very long instruction words (VLIWs) into smaller units, processable by parallel processing units 321, 322, 323, and 324 in the execute stage 303. Furthermore, an instruction memory 306, can store instructions and the fetch stage 304 can load instructions into the decode stage 305 from the instruction memory 306. The processor core 301 of FIG. 3 contains four parallel processing units 321, 322, 323, and 324. However, the core 301 can have any number of parallel processing units without parting from the scope of the disclosure.

Data can be loaded from, or written to, data memories 308 from a registers or register file 307. Generally, data memories can provide data and can save the results of the arithmetic proceeding provided by the execute stage. The program flow to the parallel processing units 321-324 of the execute stage 303 can be influenced for every clock cycle with the use of at least one control unit 309. The architecture shown provides connections between the control unit 309, processing units, and all of the stages 303, 304 and 305.

The control unit 309 can be implemented as a combinational logic circuit. The control unit can receive instructions from the fetch 304 or the decode stage 305 (or any other stage) for the purpose of coupling processing units for specific types of instructions or instruction words, for example, for a conditional instruction. In addition, the control unit 309 can receive signals from an arbitrary number of individual or coupled parallel processing units 321-324, which can signal whether conditions are contained in the loaded instructions.

Typical instruction processing pipelines known in the art have a fetch stage 332 and a decode stage 334 as shown in FIG. 1. The parallel processing architecture of FIG. 3 has a fetch stage 304 which loads instructions and immediate values (data values which are passed along with the instructions within the instruction stream) from an instruction memory system 306 and forwards the instructions and immediate values to a decode stage 305. The decode stage can expand and split the instructions and passes the instructions to the parallel processing units 321-324.

FIG. 4 illustrates a processing pipeline which can be implemented by the processor core 210 of FIG. 2. The vertical bars 409, 419, 429, 439, 449, 459, 469, and 479 can denote pipeline registers. The modules 411, 421, 431, 441, 451, 461, and 471 can read data from a previous pipeline register and may store a result in the next pipeline register. The modules with pipeline registers can form a pipeline stage. Other modules may send signals to none, one, or several pipeline stages which can be the same stage, a previous stage, or a next pipeline stage.

The pipeline shown in FIG. 4 can consist of two coupled pipelines. One pipeline can be an instruction processing pipeline which can process the stages between the bars 429 and 479. Another pipeline which is tightly coupled to the instruction processing pipeline can be the instruction cache pipeline which can process the steps between the bars 409 and 429.

The instruction processing pipeline can consist of several stages which can be a fetch-decode stage 431, a forward stage 441, an execute stage 451, a memory and register transfer stage 461, and a post-sync stage 471. The fetch-decode stage 431 can contain of a fetch stage and a decode stage. The fetch-decode stage 431 can fetch instructions and instruction data, can decode the instructions, and can write the fetched instruction data and the decoded instructions to the forward register 439. Instruction data can be a value which is included in the instruction stream and passed into the instruction pipeline along with the instruction stream. The forward stage 441 can prepare the input values for the execute stage 451. The execute stage 451 can consist of a multitude of parallel processing units as explained with the processing units 321, 322, 323, or 324 (321-324) of the execute stage 303 in FIG. 3. In one embodiment, the processing units 321-324 can access the same register file as it has been explained with the register file 307 in FIG. 3. In another embodiment, each processing unit 321-324 can access a register file that is dedicated to the individual processing unit (i.e. 321, 322, 323 and 324).

An instruction sent to a processing unit of the execute stage can be to load a register with instruction data provided with the instruction. However, the loading of the data can take several clock cycles because the data must propagate from the execute stage which has executed the load instruction to the register. In conventional pipeline designs without a so-called forward functionality, the pipeline may have to stall until the data is loaded into the register to be able to load the register data. Other conventional pipeline designs may not stall in this case but might disallow the programmer to query the same register in one or a few next cycles in the instruction sequence.

However, in one embodiment, a forward stage 441 can provide data utilizing a bypass route such that data can be loaded to registers in one of the next cycles and the data can be quickly merged with instructions in the execute stage. In parallel, data can be propagated through the pipeline and/or additional modules towards the registers.

In one embodiment, the memory and register transfer stage 461 can be responsible to transfer data from memories to registers or from registers to memories. The stage 461 can control the access to one or even a multitude of memories which can be a core memory or an external memory. The stage 461 can communicate with external periphery through a peripheral interface 465 and can access external memories through a data memory sub-system (DMS) 467. The DMS control module 463 can be used to load data from a memory to a register whereas the memory is accessed by the DMS 467.

The disclosed pipeline can process a sequence of instructions in one clock cycle. However, each instruction processed in the pipeline can take several clock cycles to pass all stages. Hence, it can happen, that data is loaded to a register in the same clock cycle when an instruction in the execute stage requests the data. Therefore, embodiments of the disclosure can have a post sync stage 471 which has a post sync register 479 to hold data in the pipeline when this is desired. The data can be directed from register 479 to the execute stage 451 by the forward stage 441 while it is loaded in parallel to the register file 473 as described above.

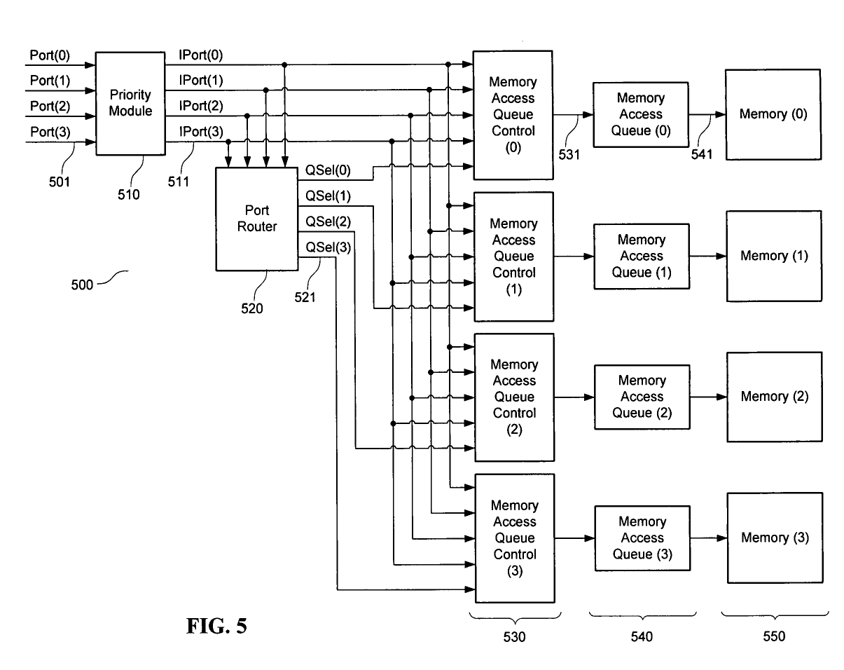

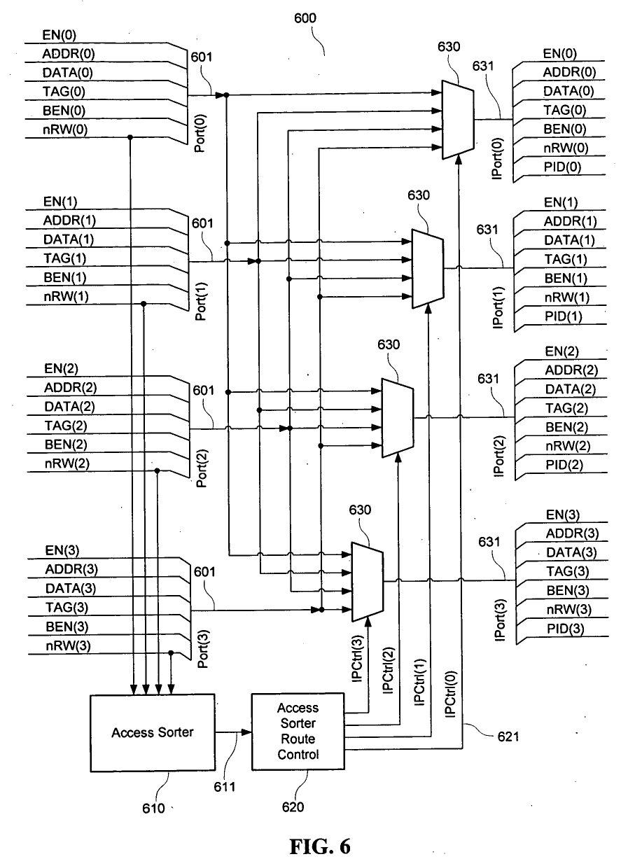

FIG. 5 shows another embodiment of a processing system 500. A priority sorting module or priority module 510, can receive a plurality of memory requests 501. The memory requests 501 can be issued from a processing unit and can be a load requests (read request) or a write request or a combination thereof. The signals 501 can be referred to as “external ports” within this disclosure. The module 510 can receive a minimum of zero and a maximum of K memory requests 501 from K ports. In FIG. 5 K is four however this is not limiting. The priority module 510 can sort or prioritize the requests 501, outputting the sorted and “rearranged” requests with signals 511. Signals 511 can be referred to as “internal ports” or IPorts as they represent the incoming signals 501 in a different order. The order which the memory requests are processed can be determined by the module 510.

A router module 520 can determine which request of an internal port 511 should be forwarded to each memory module of the L memory access queue control modules 530. In the embodiment of FIG. 5, all internal ports 511 can be forwarded to each memory access queue control module 530 and a selector signal 521 which can be generated by the module 520, can be send to each of the memory access queue control modules 530. The memory access queue control modules 530 can use the selector signals 521 to determine which of the internal ports 511 will receive the requests. Depending on the selector signal 521, a memory access queue control module 530 can accept a minimum of zero and a maximum of K internal ports in each clock cycle, whereas in the example of FIG. 5 K equals to four.

The embodiment 500 can have L memory modules 550 where each memory module 550 can have an access queue 540. The access queue 540 can act as a master to the memory modules 550 and the queue 540 can issue memory requests 541 to a corresponding memory module 550. Each access queues 540 can provide a similar function for each memory module 550. Each access queue 540 can queue a number of requests such as “N” requests. In one embodiment, each of the queues 540 can issue one request 541 to a memory 550 each clock cycle. Hence, during each clock cycle, a maximum of L requests can be issued and handled by all memory modules 550. However, if some or all queues 540 are empty, L-1 to zero requests can be issued by the queue 540.

Each memory access queue 540 can receive up to K requests from its corresponding memory access queue control module 530 at each clock cycle. However, in each clock cycle, only one request can be send by a queue 540 to the corresponding memory module 550 as discussed above. Therefore, in some embodiments a queue 540 could have an overflow. In one embodiment a memory access queue 540 cannot estimate how many requests will be accepted by the corresponding memory access queue control module 530 and, as depicted above a queue 540 can store N requests, can receive up to K requests in a clock cycle, and can issue one request to the corresponding memory in a clock cycle. Operating in this configuration, each memory access queue 540 can send a stall signal when the queue 540 is filled to a certain degree, where the queue can have a stall limit M_{Q}. For example, the queue 540 can send a stall signal to the control module 530 when more than M_{Q}=N−K+1 requests are stored in a queue 540. This stall signal can in one embodiment cause the main pipeline to stall until maximal N−K+1 requests are in the queue 540. Hence, a memory access queue 540 which can store N−K+1 requests can, in one clock cycle, issue one request to a memory module (leaving N−K open requests in the queue) and receive up to K new requests. When the queue 540 receives K requests, the queue 540 would be full, storing N requests. In another embodiment, the queue stall limit could be M_{Q}=N−K. A full queue would need a minimum of K clock cycles to be able to accept new requests in case it cannot predict the number of requests that will be accepted in a next cycle. Once a queue 540 can accept a maximum of K requests in a next cycle, the pipeline can be released via a control signal. However, as described above, if the length of the queue N is larger or equal to the number of requests that can be raised by the processor, the queue may not need to send a stall signal to the pipeline.

FIG. 6 shows a system 600 having a priority module 510 that can prioritize requests. The module 510 can receive four external port signals 601 which can be the signals 501. Each signal 601 can comprise an enable signal, “EN” indicating whether a memory request is issued and correspondingly if other related signals are valid or invalid. Each single can also include an address signal, “ADDR” containing the address, a data signal, “DATA” containing data that shall be written in case of a write request, a tag signal, “TAG” containing a tag from a memory subsystem control which ties a tag to a memory request in order to manage all pending requests, a byte enable signal, “BEN” telling which bytes at the specified address shall be loaded or written (e.g., in case of 32-bit only memory accesses the signal BEN can specify, which of the four bytes in 32-bit data are of interest), and a read/write signal nRW telling whether the request is a read request or a write request.

In FIG. 6 an access sorter module 610 can utilize signals of the external ports 601 to generate a decision signal 611 controlling an access sorter route control module 620 regarding how the external port signals 601 can be assigned to internal IPorts 631. The access sorter route control module 620 can provide control signals 621 to switch a switching logic 630. The switching logic 630 can route the signals 601 to internal ports 631 using the signals 621. The signals PID of the internal ports 631 can include port identifiers which can denote the number of the external port 601 that corresponds to the internal port 631 where the request was received. For instance, depending on the nRW signals of the signal 601 the access sorter 610 can instruct the access sorter route control module 620 to switch the switching logic 630 to crosswise exchange the input signals 601. Sorting of requests can send requests to different ports when the requests aim at the same address at the same cycle or for cycles that are in close proximity to each other.

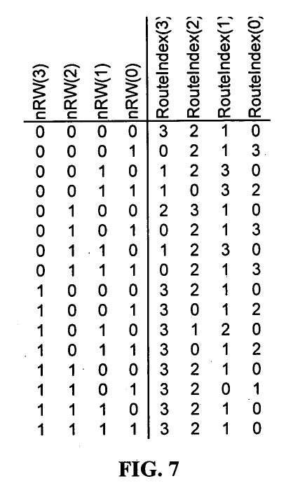

FIG. 7 shows a decision table which can be used in an example access sorter 610. The access sorter can generate output signals RouteIndex which can be used by an access sorter route control module 620. The table can assume an access sorter 610 which can receive nRW signals of the external ports 601 according to the embodiment shown in FIG. 6. The RouteIndex signals can define the assignment of external ports 601 to internal ports 631. The module 610 can be implemented with a look-up table, combinatorial logic or any other logic or elements. Moreover, it is to note that the access sorter can have any other logic to sort or prioritize external ports.

FIG. 7 shows the signals RouteIndex for all input combinations of the signals nRW. A signal nRW can be low for a read request or high for a write request. The table of FIG. 7 can be used by an embodiment of an access sorter 610 to assign externals ports with read access a higher priority over those having write access. For example, if the external port 1 requires write access and all other ports require read access, the nRW signals according to the table of FIG. 7 can have the values (0 1 0 0) which can result in the signals (2 3 1 0) for the RouteIndex according to FIG. 7 which means: port(3) is mapped to IPort(2), port(2) is mapped to IPort(3), port(1) is mapped to IPort(1) and port(0) is mapped to IPort(0).

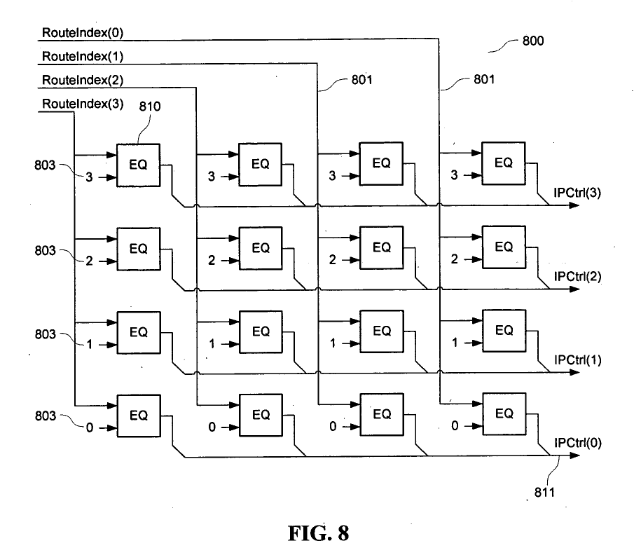

FIG. 8 shows an example implementation 800 of an access sorter route control 620. The access sorter route control 620 can receive RouteIndex signals 801 which can be generated by an access sorter 610 using at least one table like that of FIG. 7 as described above. The access sorter route control 620 can use comparators 810 to compare the RouteIndex signals with the numbers 803 of internal ports. The result of comparisons can be combined to signals IPCtrl(p) where p denotes the number of the internal port. I.e., IPCtrl(p) can be a signal that indicates which of the external ports has to be assigned to the internal port p. The switching logic 630 can use the signals IPCtrl 621 to assign the external ports 601 to the internal ports IPort(p) 631 as shown in FIG. 6.

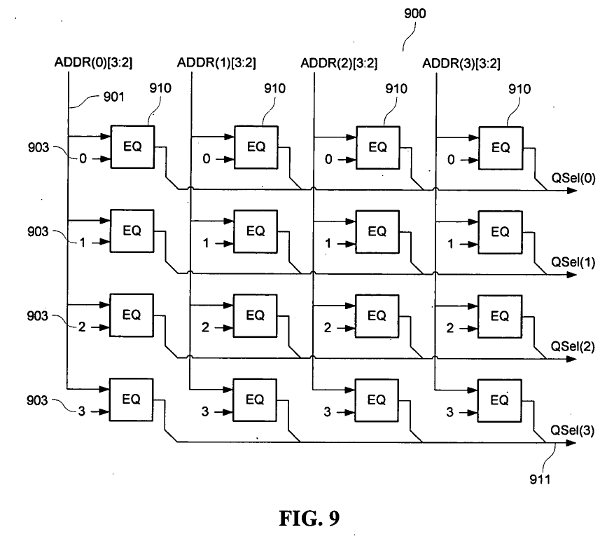

FIG. 9 illustrates a routing system 900 that includes a port router 520. The port router 520 can generate selection signals which can be used by subsequent memory access queue control modules 530 to determine the internal ports that have to be scheduled in the queues 540. The system 900 can receive memory addresses 901 of the internal ports 511 and can use comparators 910 to compare parts of the memory addresses 901 of the internal ports with a queue number 903. The module 900 can use the comparators 910 to generate output signals QSel 911. Each output signal QSel(q) 911 can signal a subsequent queue which of the internal ports 511 can be scheduled.

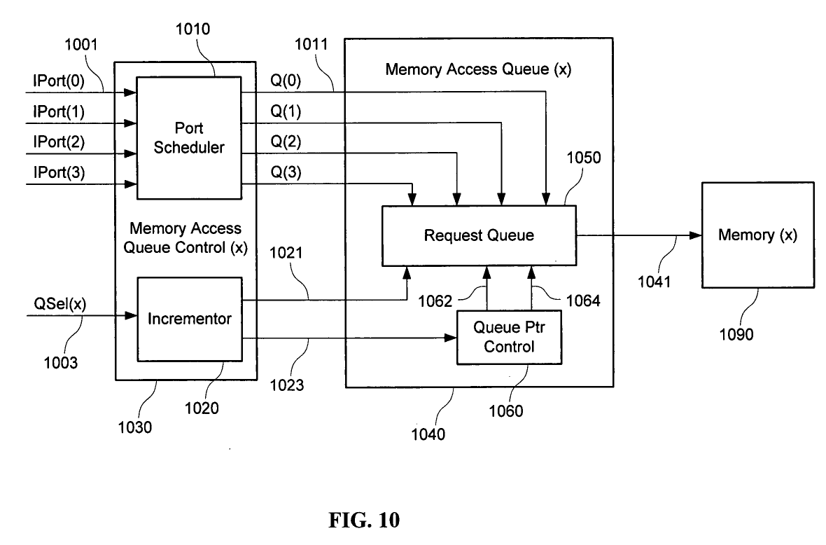

FIG. 10 shows an example embodiment 1030 for a memory access queue control module 530 and an example embodiment 1040 for a memory access queue 540. The memory access queue control module 1030 can include a port scheduler 1010 and an incrementor 1020. The port scheduler 1010 can receive up to K internal ports 1001, can rearrange the K internal ports 1001, and can forward the rearranged internal ports 1011 to a memory access queue 1040. The internal ports 1001 can be the internal ports 511 of FIG. 5. The rearranging done by the port scheduler 1010 can be performed in a way that unused internal ports are removed. For example when only the internal ports I and 3 are used, the rearranged ports can be Q(0)=IPort(1), Q(1)=IPort(3), whereas Q(2) and Q(3) can be tagged as unused.

The incrementor 1020 can receive the signals QSel 1003. The signals QSel 1003 can be the output signals QSel 911 of FIG. 9. The incrementor 1020 can generate enable signals 1021 which can be used by a request queue 1050. The incrementor 1020 can also generate a counter 1023 which can be used by a queue pointer control 1060.

The memory access queue module 1040 can receive the rearranged internal ports 1011, enable signals 1021, and a counter 1023 form the module 1030. The memory access queue 1040 can have a request queue 1050 which can store up to N requests and a queue pointer control 1060 which can generate a read pointer signal 1062 and a write pointer signal 1064 for queue access. The request queue 1050 can be a master of a memory 1090.

If the request queue 1050 holds less than N−K+1 requests, at each clock cycle the request queue 1050 can receive up to K requests 1011. Moreover, if the queue holds at least one request, at each clock cycle the request queue 1050 can issue one request to the memory 1090. However, if the request queue stores more than N−K+1 requests, the memory access queue 1040 can cause the pipeline 400 to stall until at most N−K+1 requests are stored in the queue. However, the request queue 1050 itself can raise one request at each clock cycle and can never stall. If at least one request 1011 is input to an empty memory access queue 1040, in some embodiments, the memory access queue can forward one of the requests 1011 directly to the memory 1090 by the signals 1041 and can only store the remaining requests in the request queue 1050.

In some embodiments, the memory access queue 1050 can make use of a read pointer 1062 and a write pointer 1064 which can be controlled by the queue pointer control 1060. The queue pointer control 1060 can receive a signal 1023 indicating how the rearranged data to internal ports 1011 should be organized and this can be stored in the request queue 1050. Hence, the signal 1023 can be a number y, telling the queue pointer control that 1060 the requests Q(0) to Q(y−1) have to be stored in the request queue 1050. A read pointer 1062 can denote the position of a request in a register array within the request queue 1050 which will be issued next. A write pointer 1064 can denote a position in a register array within the request queue 1050 where next requests shall be stored. Hence in one embodiment, the request queue 1050 can be a ring buffer and in another embodiment the request queue 1050 can be a register or a shift register.

The memory access queue 1040 can be operated such that is does not stall and during this operation that queue 1040 can issue one request to a memory 1090 at each clock cycle, if a request is stored in the queue 1040 as described above. Depending on the kind of the request 1041, data of the request 1041 can be written to the memory 1090 or data can be read from the memory 1090. However, if a read request is issued to a memory by a memory access queue 1040 the read data can be routed back to the external port which has requested the data. The routing can be done by a so-called reverse router.

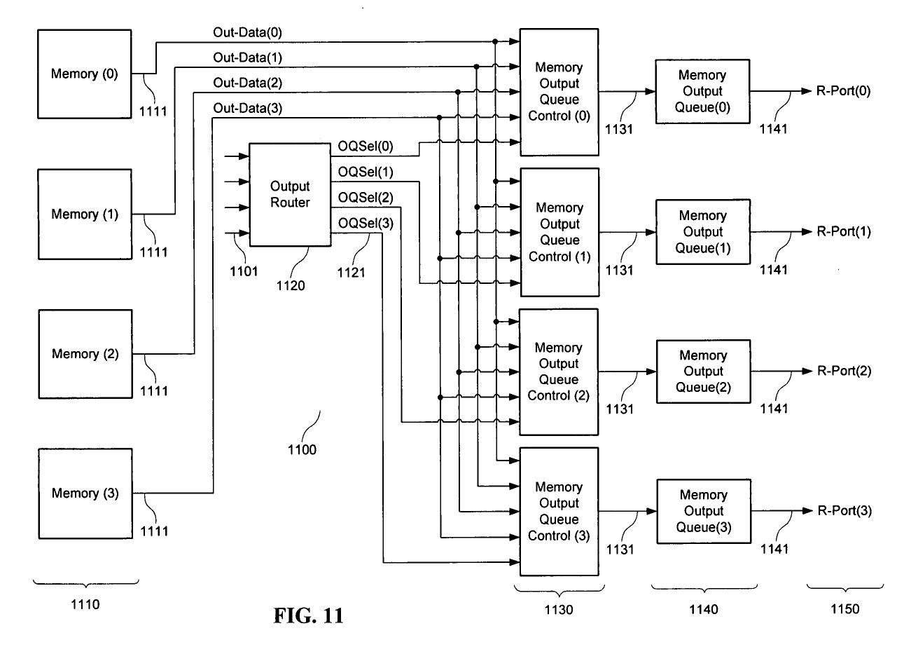

FIG. 11 shows a system 100 for reverse routing. A reverse router can route data which has been read from a memory 1110 back to the requesting port (R-Port) 1150. The memories 1110 can be similar to the memories 550 illustrated in FIG. 5.

In each clock cycle, data can be read from up to L memories 1110 according to read requests as discussed above. The read data 1111 can be forwarded to L memory output queue control modules 1130. Each memory output queue control module 1130 can control one of the L memory output queues 1140. Each of the memory output queues 1140 can serve one request port R-Port 1150.

Each of the L memory output queue control modules 1130 can receive a signal OQSel 1121 from an output router 1120 to determine the request port. For example, if an external port with an identification number PID has requested data from a memory x with the apparatus shown in FIG. 5 the data can be read from memory x and can be routed back to the request port using the identification number PID with the apparatus shown in FIG. 11. The output router 1120 can receive signals 1101 from memory access queues 1040 or the module 500 to enable the output router 1120 to associate the data with the corresponding requests and to enable the output router to detect a read requests and to detect the external ports which have requested data. Therefore, the memory output queue control modules 1130 can act as switches to route data 1111 according to routing information 1121 received from an output router 1120 to output queues 1140 which are associated to the request ports 1150.

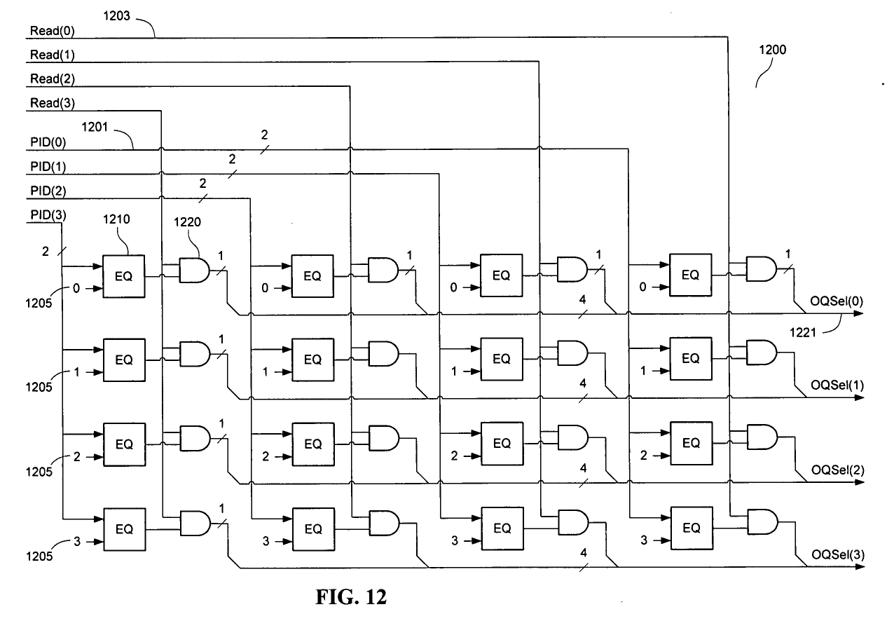

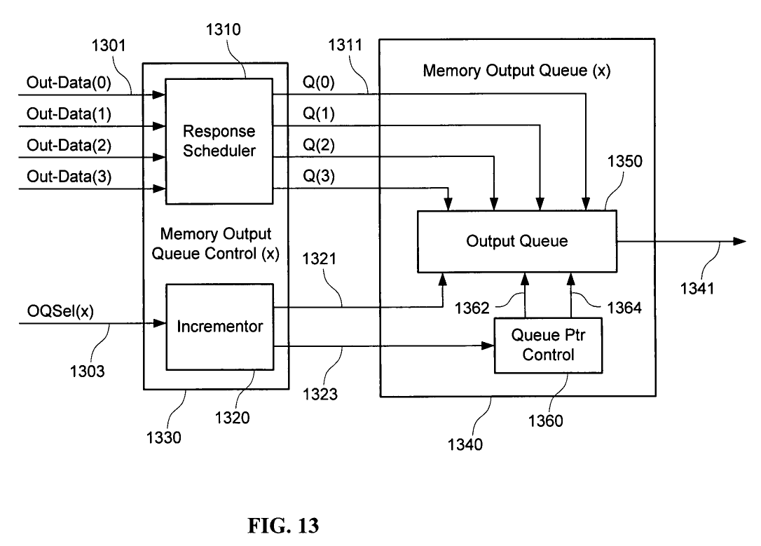

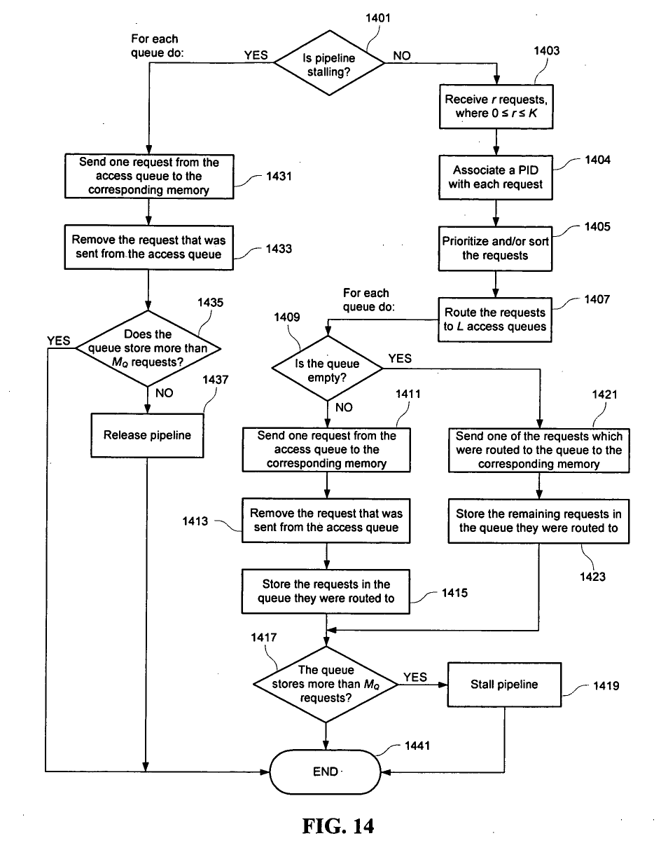

FIG. 12 shows an example of an output router 1200 according to the disclosure. The output router 1200 can be responsible to create routing signals 1221 to enable to route the data 1111 back to the request port. The output router 1200 can receive the PIDs (port identifiers) 1201 of the internal ports and read signals 1203 which indicate which of the requests actually is a read request. The read signals 1203 and the PIDs 1201 can be included in the nRW signals and the PIDs of the internal ports 631. The PIDs can be the number of the port 501 which has issued the request, the so-called request port.

The output router 1200 can use comparators 1210 and AND gates 1220 to determine the routing signals OQSel 1221. The routing signals 1221 can comprise Boolean information for each of the PIDs telling which of the PIDs are identically with a constant request port number 1205 in case the request was a read request. To determine the signals 1221 the router can use the comparators 1210 to check whether the PIDs are equal to a constant request port number 1205. The results of the comparisons can be combined with the corresponding read signals 1203 using AND operations 1220. The routing signal 1221 can tell, e.g., that all, some, or even none of the signals 1111 shall be routed to a certain request port 1150.

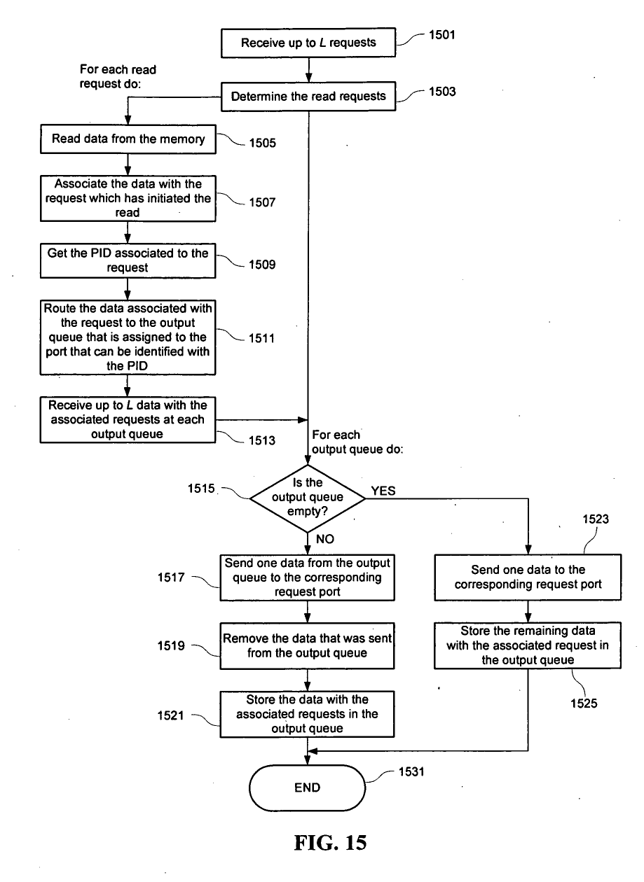

FIG. 13 is similar to FIG. 10 and shows an example embodiment 1330 for a memory output queue control module 1130 and an example embodiment 1340 for a memory output queue 1140. The memory output queue control module 1330 can similar to FIG. 10 comprise a response scheduler 1310 and an incrementor 1320. The response scheduler 1310 can receive up to L data 1301, can rearrange the L data 1301, and can forward the rearranged data 1311 to a memory output queue 1340. The data 1301 can be the internal ports 1111 of FIG. 11. The rearranging performed by the response scheduler 1310 can be necessary to feed only valid data into the queue 1340.

The incrementor 1320 can receive the signals OQSel 1303. The signals QSel 1303 can be the output signals OQSel 1211 of FIG. 12. The incrementor 1320 can generate enable signals 1321 which can be used by a request queue 1350. The incrementor 1320 can also generate a counter 1323 which can be used by a queue pointer control 1360.

The memory output queue module 1340 can receive the rearranged data 1311, enable signals 1321, and a counter 1323 form the module 1330. The memory output queue 1340 can have an output queue 1350 which can store up to M requests and a queue pointer control 1360 which can generate a read pointer signal 1362 and a write pointer signal 1364 for output queue access.

The output queue 1350 never stalls and can never run into an overflow if the length of the output queue M is larger or equal to the number of tags available in the memory subsystem for the processing unit 170 to which the memory output queue is associated to. Hence, if T is the number of tags available for a processing unit 170 in a memory subsystem, M has to be at least T (or in some embodiments T−1). In this case, the output queue will never stall because only a maximum of T requests can be raised by a processing unit.

In some embodiments, the memory output queue 1350 can make use of a read pointer 1362 and a write pointer 1364 which can be controlled by the queue pointer control 1360. The queue pointer control 1360 can receive a signal 1323 indicating how the data 1311 has been rearranged and the indications can be stored in the output queue 1350. A read pointer 1362 can denote in some embodiments a position in a register array within the request queue 1350 that contains the data that will be output next. A write pointer 1364 can denote the position in a register array within the request queue 1350 where rearranged data shall be stored. Hence, in one embodiment of the disclosure the request queue 1350 can be a ring buffer and in another embodiment of the disclosure a shift register. The memory output queue 1340 may never stall and can forward data 1341 to the processing unit 170 at each clock cycle, if at least one data is stored in the queue. It is to note that the modules 1330 and 1340 can be implemented like the modules 1030 and 1040, however, the queue lengths may be chosen different up to the implementation. Moreover, the module 1030 can receive K request signals 1001 and can output K request signals 1011 whereas the module 1330 can receive L request response signals 1301 and can output L request response signals 1311.

It can be appreciated that that a multitude of K parallel processing units 170 can access a multitude of L memory modules 140 using a multi-port access control module 180 whereby the memory modules can be simple single ported memories. The multi-port access control module 180 can be implemented with a low number of logic elements to provide a low cost multi-ported memory system. Moreover, the multi-port access control module can make use of memory access queues which can act as a master to the single port memories and can have memory output queues which can return the data read from the memories to the processing units. Queues may rarely stall, however, the memory access queue can cause the pipeline to stall in case of an overflow of requests. Hence, the multi-port access control 180 can be implemented such that stalls are not the norm and the system can handle L memory requests at each clock cycle. Moreover, the multi-port access control is completely scalable to serve K processing units and L memories. Other advantages are that the multi-port access control 180 can prioritize or sort incoming requests and can resolve concurrent memory requests.

FIG. 14 is a flow diagram of a method for issuing up to K memory requests from K ports to a multi-port access control module 500. At decision block 1401, it can be determined whether the pipeline stalls or not. If the pipeline is in regular operation and does not stall, r requests can be received, as illustrated by block 1403 whereas 0≦r≦K. As illustrated by block 1404, the PID (port identification number) of the request port can be associated to each request. As illustrated by block 1405, the requests can be sorted and/or prioritized. The so arranged requests can be routed to L access queues, as illustrated by block 1407. For each access queue the following steps can be performed: at decision block 1409 it can be determined whether the queue is empty or not. If the queue is empty, one of the requests which were routed to the access queue can be send to the memory the access queue is assigned to, which is illustrated by block 1409. As illustrated by block 1423 the remaining requests can be stored in the queue. However, if the queue is not empty, one request can be send from the queue to the corresponding memory as illustrated by block 1411. The request that was sent to the access queue can then be removed from the queue as illustrated by block 1413. The requests which have been routed to the access queue can be stored in the queue as illustrated by block 1415. Once the requests could have been stored at decision block 1417 it can be determined if the queue stores more than M^{Q} requests. If the queue stores more than M^{Q} requests a signal can be sent to the pipeline causing the pipeline to stall as illustrated by block 1419. The process of issuing a request then ends as illustrated by block 1441 and can be re-invoked at each clock cycle at block 1401.

If it can be determined at decision block 1401 that the pipeline is stalling, for each access queue, the following steps can be performed: new requests are not accepted by the access queues. Instead, one request from the access queue can be sent to the corresponding memory as illustrated by block 1431. The request that was sent to the memory can be removed from the access queue as illustrated by block 1433. At decision block 1435 it can be determined if the access queue stores more than M^{Q} requests. If the access queue does not store more than M^{Q} requests, the pipeline (which is stalling) can be released as illustrated by block 1437. The process of issuing a request can end at block 1441 and can be re-invoked at each clock cycle at block 1401.

FIG. 15 is a flow diagram of a method for reading up to L data from L memory modules and forwarding the data to K ports. As illustrated by block 1501 up to L requests can be received by L memory modules. As illustrated by block 1503, it can be determined for each request whether the request was a read or a write request. For each read request the following steps can be performed: data can be read from the memory according to the read request as illustrated by block 1505 and the read request can be associated with the request as illustrated by block 1507. As illustrated by block 1509 the PID (port identification number) can be determined for each read request. The data and certain information of the read request the data is associated to can be routed to the output queue that is assigned to the port that can be identified with the PID as illustrated by block 1511.

As illustrated by block 1513 each of the output queues can receive up to L data with their associated requests. For example, if no read request was issued, no data can be routed to any port. If one read request was issued, only one output queue (the queue of the requesting port) can receive the data. However, in the case that L read requests were processed, it can happen that one output queue receives all data or that the data of the L requests is routed to different queues. It is to note, that the workload of the queues and the processed request can vary from clock cycle to clock cycle and can depend on the sequence the requests were issued, on the algorithm used for the priority module 510, and on to which extend the access queues 540 and/or the output queues 1140 are filled.

For each output queue the following steps can be performed: at decision block 1515 it can be determined if the output queue is empty. If the output queue is empty, in some embodiments one of the data received by the queue can be sent to corresponding request port as illustrated by block 1523. As illustrated by block 1525 the remaining data that were sent to the output queue can be stored in the queue. However, if the output queue is not empty, one data from the output queue can be sent to the corresponding request port as illustrated by block 1517. As illustrated by block 1519, the data that could be sent to the request port can be removed from the output queue. As illustrated by block 1521, the data that were sent to the output queue can be stored in the queue. The process of reading data from memories and forwarding them to request ports can end at block 1531 and can be re-invoked at each clock cycle at block 1501.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The control module can retrieve instructions from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can automatically tune a transmission line. It is understood that the form of the arrangements shown and described in the detailed description and the drawings are to be taken merely as examples. It is intended that the following claims be interpreted broadly to embrace all the variations of the example embodiments disclosed.

What is claimed is:

1. A memory system comprising:
a plurality of single ported memory modules;
an identifier module to identify a memory access request from a plurality of memory access requests based on a port that receives the memory access request;
a memory access controller coupled to the plurality of single ported memory modules, the memory access controller having a plurality of inputs to accept the plurality of memory requests on a concurrent basis and to prioritize and queue the identified memory access request to one single ported memory module of the plurality of single ported memory modules; and
a router to route results of the memory access request to an output port from a plurality of output ports based on the identity of the memory access request.

2. The memory system of claim 1, further comprising an input port coupled to the single ported memory modules, the input port having a plurality of inputs, the inputs having a correlation to the plurality of output ports, wherein results of the memory request are returned exclusively to an output port that correlates to the input port based on the identity of the memory access request.

3. The memory system of claim 1, further comprising a plurality of output queue modules to accept results from the memory access request and output the result to an output port of one of the plurality of output ports.

4. The memory system of claim 1, wherein the memory access controller comprises a plurality of access queue modules to feed the plurality of single port memory modules with the memory requests.

5. The memory system of claim 4, wherein the access queue modules further comprise an access queue for each memory module.

6. The memory system of claim 5, wherein data in memory is organized such that concurrent memory access requests are routed to different single ported memory modules in the plurality of memory modules in processing the majority of requests.

7. The memory system of claim 1, wherein the memory module comprises a scheduler to schedule the plurality of requests.

8. The memory system of claim 1, wherein the memory access controller comprises a prioritization module to prioritize the plurality of requests.

9. The memory system of claim 8 wherein the prioritization module prioritizes a read request over a write request.

10. A method for operating a memory system comprising:
receiving a plurality of memory access requests at a plurality of ports;
tagging the memory access request with a port identifier based on a port in the plurality of ports that the memory access request is received;
prioritizing the requests;
detecting addresses of the requests;
routing one request from the plurality of requests to a single port memory module based on the detected address of the request; and
routing a result of the one request to an output port based on the tagging.

11. The method of claim 10, further comprising storing data in the memory modules based on a predicted order of receiving the memory access requests.

12. The method of claim 10, wherein prioritizing comprises assigning a higher priority to a read memory access request that a priority assigned to a write memory access request.

13. The method of claim 10 wherein routing comprises routing the memory access request to an access queue.

14. The method of claim 13, further utilizing a routing table to route the request.

15. The method of claim 13, further comprising providing one request from an access queue to the single input memory module for each cycle.

16. A computer program product comprising a computer useable medium having a computer readable program, wherein the computer readable program when executed on a computer causes the computer to:
receive a plurality of memory access requests at a plurality of ports;
assign an identity the memory access request based on a port of the plurality of ports that the memory access request is received;
prioritize the requests;
detect addresses of the requests;
route one request from the plurality of requests to a single port memory module based on the address of the request; and
route a result of the one request to an output port based on the identity.

17. The computer program product of claim 16, further comprising a computer readable program when executed on a computer causes the computer to store data in the memory modules based on a predicted processing order of the data.

18. The computer program product of claim 16, further comprising a computer readable program when executed on a computer causes the computer to prioritize a read memory access request as a higher priority than a write memory access request.

19. The computer program product of claim 16, further comprising a computer readable program when executed on a computer causes the computer to route the memory access request to an access queue.

20. The computer program product of claim 19, further comprising a computer readable program when executed on a computer causes the computer to bypass the access queue in response to the access queue being empty.
